(19) United States
(12) Patent Application Publication
(10) Pub. No.: US 2021/0185088 A1
(43) Pub. Date: Jun. 17, 2021

(54) METHOD OF AUTHENTICATION MANAGEMENT FOR EQUIPMENT IN A DATA COMMUNICATION SYSTEM, AND SYSTEM FOR IMPLEMENTING THE METHOD

(71) Applicant: ELECTRICITE DE FRANCE, Paris (FR)

(72) Inventor: Thierry LUCIDARME, Chevreuse (FR)

(73) Assignee: ELECTRICITE DE FRANCE, Paris (FR)

(21) Appl. No.: 17/124,938

(22) Filed: Dec. 17, 2020

(30) Foreign Application Priority Data
Dec. 17, 2019 (FR) 1914631

(51) Int. Cl. H04L 29/06

(52) U.S. Cl. CPC H04L 63/18; H04L 63/1425; H04L 63/126; H04L 63/0876

(57) ABSTRACT

A method for managing authentication of an equipment in a data communication system for exchange of data between the equipment and an application server of the system, the system including a first data communication network for using a first security function for securing data communication within the first network, operatively coupled to a second data communication network for using a second security function for securing data communication within the second network including, in an authentication management unit of the system implemented in a node of the second communication network: receiving an authentication request from the equipment according to the second security function for access to the application server; determining whether an equipment identifier in the first communication network was received further to receiving an authentication request from the equipment according to the first function; and, when the equipment identifier was not received, generating an authentication failure response for the equipment.

### CROSS-REFERENCE TO RELATED APPLICATION

This application claims priority benefit under 35 U.S.C. § 119(d) from French Patent Application No. FR1914631, filed Dec. 17, 2019, the disclosure of which is incorporated by reference herein in its entirety.

### FIELD

The present method relates to a method of authentication management for equipment in a data communication system, and also to equipment and a computer system for implementing this method. It applies in particular to data communications systems comprising one or more intelligent electrical grids and connected intelligent terminal equipment.

### BACKGROUND

The development by the 3GPP organization (“Third Generation Partnership Project”) of technical specifications for fifth generation (5G) wireless system leads to considering the upcoming deployment of 5G networks in connection with vertical type applications, such as for example the management of smart electric energy consumption meters. Intelligent terminal equipment, called IED (“Intelligent Electronic Device”), will be connected to data communications networks in order to exchange data with one or more service management application servers by a dedicated service operator having its own network infrastructure or by service provider companies (“utility companies”) operating a network. The use of wireless 5G networks is therefore anticipated in the context of intelligent electrical grids (also called “smart grid”) using IED equipments connected to a 5G network.

The use of 5G wireless networks in the context of smart grid type networks using connected IED equipments raises the question of securing data exchanges between an IED equipment and a server of the intelligent electrical network. This question has not yet been explored.

### SUMMARY

The present disclosure aims to improve the situation.

According to a first aspect, a method for managing authentication of an equipment in a data communication system for exchange of data between the equipment and an application server of the system is proposed, wherein the system comprises a first data communication network configured for using a first security function for securing data communication within the first network, operatively coupled to a second data communication network configured for using a second security function for securing data communication within the second network, wherein the method comprises, in an authentication management unit of the system implemented in a node of the second communication network: receiving an authentication request from the equipment according to the second security function for access to the application server; determining whether an equipment identifier in the first communication network was received further to receiving an authentication request from the equipment according to the first function; and, in case the equipment identifier was not received, generating an authentication failure response for the equipment.

The characteristics disclosed in the following paragraphs may, optionally, be implemented. They can be implemented independently of each other or in combination with each other:

In one or more embodiments, the proposed method may further comprise: receiving an authentication request from the equipment according to the first security function on the first communication network, wherein the authentication request uses the equipment identifier.

In one or more embodiments, in which the system further comprises a database preconfigured with a correspondence between the identifier and the security element for the second security function for authentication requests from the equipment according to the second function addressed to the second network, the proposed method may further comprise: sending to the database a request for verification of recording the received identifier in the database, wherein the request comprises the received identifier.

In one or more embodiments, the proposed method may further comprise: upon receiving a response of absence of a record for the received identifier in the database, or a response indicating an anomaly relative to one or more previous authentication requests for the equipment according to the first security function in the first communication network and/or according to the second security function in the second communication network, generating the authentication failure response for the equipment.

In one or more embodiments in which the system further comprises a database preconfigured with a correspondence between the identifier and a security element for the second security function for authentication requests from the equipment according to the second function addressed to the second network, the proposed method may further comprise: receiving an authentication request from the equipment according to the second security function in the second communication network, wherein the authentication request uses the security element; sending to the database a request for verification of recording the received identifier corresponding to the received security element in the database, wherein the request comprises the received identifier and the received security element.

In one or more embodiments, the proposed method may further comprise: upon receiving a response from the database indicating that there is no correspondence between the identifier and the received element, generating the authentication failure response for the equipment.

In one or more embodiments, the proposed method may further comprise: initializing a timer to a preset duration upon receiving the authentication request from the equipment according to the first security function on the first communication network; and when no authentication request for the equipment according to the second security function on the second communication network is received before expiration of the timer, generating the authentication failure response for the equipment.

In one or more embodiments, in which the system further comprises a database preconfigured with a correspondence between the identifier and a security element for the second security function for authentication requests from the equipment according to the second function addressed to the second network, the proposed method may further comprise: sending to the database a request for recording of the authentication failure of the equipment corresponding to the identifier and/or the security element.

In one or more embodiments in which the equipment is provided with an initial security element for the second security function for authentication requests for the equipment according to the second function addressed to the second network, the proposed method may further comprise: receiving an authentication request from the equipment according to the second security function on the second communication network, wherein the authentication request uses the initial security element; generating an authentication success response for the equipment in order to authorize access of the equipment to the application server; upon receiving a message from the application server indicating that the equipment is recorded in the application server by using a secured connection between the equipment and the application server following authentication success of the equipment, obtaining an operator security element; and sending the operator security element to the application server for sending to the equipment by using the secured connection.

In one or more embodiments, in which the system further comprises a database preconfigured with the correspondence between the identifier and the initial security element for the second security function for authentication requests from the equipment according to the second function addressed to the second network, the proposed method may further comprise: sending to the database a request for updating the initial security element with the operator security element.

In one or more embodiments, in which the system further comprises a database preconfigured with the correspondence between the identifier and a security element for the second security function for authentication requests from the equipment according to the second function addressed to the second network, the proposed method may further comprise: sending to the database a request for recording the authentication failure of the equipment corresponding to the identifier and/or the security element.

Another aspect relates to a computer program, loadable in a memory associated with the processor, and comprising code portions for implementation of a method such as proposed in the present subject disclosure during execution of said program by the processor.

Another aspect relates to the management of data representing, for example by means of compression or encoding, a computer program such as proposed in the present subject disclosure.

Another aspect relates to a nonvolatile storage medium for a computer executable program, comprising a set of data representing one or more programs, wherein said one or more programs comprise instructions for, during execution of said one or more programs by a computer comprising a processor coupled operatively to a memory and a data communication input/output interface, driving the computer to manage a device according to a method according to one of the embodiments proposed in the present subject disclosure.

Another aspect relates to a non-transitory computer-readable storage medium for a computer executable program, comprising a set of data representing one or more programs, wherein said one or more programs comprise instructions for, during execution of said one or more programs by a computer comprising a processing unit operatively coupled with a memory and with an input/output interface module, driving the computer to implement a method according to one of the embodiments proposed in the present subject disclosure.

### BRIEF DESCRIPTION OF THE DRAWINGS

Other specifics and advantages of the present disclosure will appear in the following description of nonlimiting implementation examples, referring to the attached drawings in which:

FIG. 1 is a drawing showing a system example according to one or more embodiments;

FIG. 2a is a drawing showing a network architecture example for the implementation of the proposed method according to one or more embodiments;

FIG. 2b is a drawing showing a security function example in an EPS network for the protection of the user plane;

FIG. 2c is a drawing showing a system architecture example for the implementation of the proposed method according to one or more embodiments;

FIG. 3 is a diagram showing a method according to one or more embodiments;

FIG. 4 is a diagram showing a double authentication example according to one or more embodiments;

FIG. 5a is a diagram showing a double authentication sequence example for equipment according to one or more embodiments;

FIG. 5b is a diagram showing an example of supplying an “operator” certificate by replacing the initial certificate with which the IED equipment was provided according to one or more embodiments;

FIG. 6 is a diagram showing an equipment architecture example for the implementation of the proposed method according to one or more embodiments.

### DETAILED DESCRIPTION

In the following detailed description of embodiments of the invention, many specific details are presented to provide a more complete understanding. However, the person skilled in the art would understand that embodiments can be put into practice without these specific details. In other cases, well-known characteristics are not described in detail for avoiding unnecessarily complicating the present subject disclosure.

The present subject disclosure refers to functions, motors, units, modules, platforms and illustrations of diagrams of the methods and devices according to one or more embodiments. Each of the functions, motors, modules, platforms, units and diagrams described can be implemented in form of hardware, software (including in embedded software (“firmware”), or “middleware” form), microcode or any combination thereof. In the case of implementation and software form, the functions, motors, units, modules and/or illustrations of diagrams can be implemented by computer program instructions or software code, which can be stored or transmitted on a computer readable medium, including a nonvolatile medium, or a medium stored in memory of the generic or specific computer, or any other programmable data processing apparatus or device in order to produce a machine such that the computer program instructions or the software code executed on the computer or the programmable data processing apparatus or device constitute means for implementing these functions.

The embodiments of a computer-readable support include, without being exhaustive, computer storage supports and communications supports, including any support improving the transfer of a computer program from one area to another. “Computer storage support(s)” is understood to mean any physical support which can be accessed by a computer. Examples of computer storage support include, without limitation, disks or flash memory components or any other flash memory devices (for example USB keys, memory keys, memory sticks, disk keys), CD-ROMs or other optical data storage devices, DVDs, magnetic disk data storage devices or other magnetic data storage devices, data memory components, RAM, ROM and EPROM memory, memory cards (“smart cards”), SSD (“Solid-State Device”) type memory and any other form of support that can be used for transporting or storing or recording data or data structures which can be read by a computer processor.

Further, various forms of computer-readable support can transmit or carry instructions to a computer, such as a router, gateway, server or any other data transmission equipment, whether it involves wired transmission (by coaxial cable, optical fiber, telephone wires, DSL cable or ethernet cable), wireless (by infrared, radio, cellular, microwave) or virtualized transmission equipment (e.g. virtual router, virtual gateway, virtual tunnel and, virtual firewall). According to the embodiments, the instructions can comprise code from any computer programming language or computer program element, such as, without limitation, assembly language, C, C++, Visual Basic, Hypertext Markup Language (HTML), Extensible Markup Language (XML), Hypertext Transfer Protocol (HTTP), Hypertext Preprocessor (PHP), SQL, MySQL, Java, JavaScript, JavaScript Object Notation (JSON), Python, and bash scripting.

Also, the terms “in particular,” “for example,” “example,” “typically” are used in the present subject disclosure for designating examples or illustrations of nonlimiting embodiments, which do not necessarily correspond to preferred or advantageous embodiments compared to other possible aspects or embodiments.

In the present subject disclosure “server” or “platform” are understood to mean any service point (virtualized or not) or device operating data processing, one or more databases, and/or data communication functions. For example, and without limitation, the term “server” or the term “platform” may refer to a physical processor operatively coupled with associated communication, database and data storage functions, or refer to a network, a group, an assembly or a complex of processors and associated data storage and network connection equipment, and also to an operating system and one or more database systems and application software for supporting services and functions provided by the server. A computer device can be configured for sending and receiving signals, by wireless and/or wired transmission network(s), or can be configured for data or signal processing and/or storage, and can function as a server. Thus, equipment configured for operating as server can include, as a nonlimiting example, rack-mounted dedicated servers, office computers, portable computers, service gateways (sometimes called “box” or “residential gateway”), multimedia decoders (sometimes called “set-top boxes”), integrated equipment combining various functionalities, such as two or more functionalities mentioned above. Servers may vary greatly in their configuration or their capacity, a server will generally include one or more central processing unit(s) and memory. A server may also include one or more bulk memory equipment, one or more electric power supplies, one or more wireless and/or wired interfaces, one or more input/output interfaces, one or more operating systems, such as Windows server, Mac OS X, UNIX, Linux, FreeBSD, or equivalent.

The terms “network” and “communication network” such as used in the present subject disclosure refer to one or more data links which may couple or connect equipment, which may be virtualized, so as to allow electronic data transport between computer systems and/or modules and/or other electronic devices or equipment, such as a server and a client device or other types of devices including between wireless devices coupled or connected by a wireless network, for example. The network may also include bulk memory for storing data, such as NAS (“network-attached storage”), or SAN (“storage area network”), or any other form of computer or machine-readable support, for example. The network may comprise, in whole or in part, the Internet network, or one or more local area networks (LANs), one or more when (“wide-area network”) tight networks, wired type connections, wireless type or cellular type connections, or any combination of these different networks. Similarly, subnetworks can use different architectures or be compliant or compatible with various protocols, and interoperate with larger sized networks. Various types of equipment can be used to make various architectures or various protocols interoperable. For example, a router can be used to provide a communication link or data link between two LANs which would otherwise be separated and independent.

The terms “operatively coupled,” “coupled,” “mounted,” “connected” and the variants and various forms thereof used in the present subject disclosure refer to couplings, connections, and mountings, which may be direct or indirect, and comprise in particular connections between electronic equipment or between portions of such equipment which allow operations and functioning such as described in the present subject disclosure. Also, the terms “connected” and “coupled” are not limited to physical or mechanical connections or couplings. For example, an operational coupling can include one or more wired connection(s) and/or one or more wireless connection(s) between two or more units of equipment which allow simplex or duplex communication between the equipment or portions of equipment. According to another example, an operational coupling or connection may include a wired and/or wireless connection in order to allow data communication between a server of the proposed system and other equipment of the system.

The term “managed equipment” refers to equipment in a data communication system to which the proposed method is applied for management of the authentication of the equipment.

The proposed methods and systems aim to secure data exchanges between an IED type equipment and a server (for example a network control center) connected by first and second data communication networks using different security functions for authenticating network access requests (typically a wireless communication network connected to a PDN type data communication network). Depending on the chosen embodiment, various IED equipment types or architectures may be configured for implementing the proposed authentication management method. Thus, in one or more embodiments, the IED equipment configured for the implementation of the proposed methods and systems may be equipment installed at the end user, such as for example an intelligent electric meter. In other embodiments, the IED equipment configured for the implementation of the proposed methods and systems may be concentrator type equipment to which equipment installed at the respective end users is connected, such as for example a concentrator to which intelligent electric meters are connected. In one or more embodiments various IED equipment types or architectures may be used within a single system such as proposed for implementation of the proposed authentication management method.

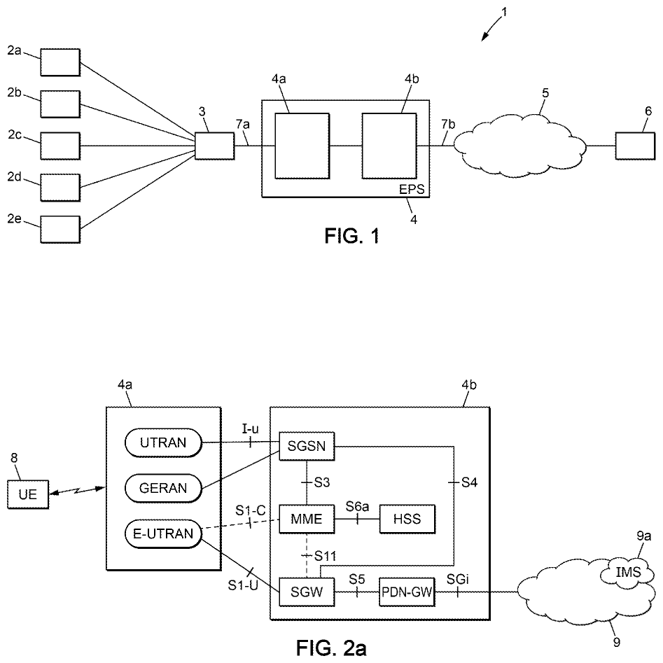

FIG. 1 shows an example of a system (1) comprising a set of terminal equipment (2a, 2b, 2c, 2d, 2e) connected through concentrator equipment (3) to an EPS (“Evolved Packet System”) type telecommunications network (4), for example 4G or 5G type, connected to a data communication network (5), such as for example an IP (“Internet Protocol”) network, to which a server (6) is connected for data communication with the terminal equipment (2a, 2b, 2c, 2d, 2e) and/or concentrator (3).

The EPS network (4) will typically comprise an interconnected access network (4a) and core network (4b), wherein the concentrator equipment (3) is connected to the access network (4a) by a data communication link (7a) comprising a radio link and the data communication network (5) is connected to the core network (4b) by a data communication link (7b).

The person skilled in the art will understand that the proposed methods and systems are not limited to one or several specific types of communication links, whether for data communication between a concentrator node (3) and an EPS network (4), for the communication of data between an EPS network (4) and a data communication network (5), or for communication of data between the data communication network (5) and a server (6). Similarly, the proposed methods and systems are not limited to one or more specific network types and/or architectures, whether it is a matter of the EPS network (4) or the data communication network (5). Thus, depending on the chosen embodiment, the proposed methods and systems may be implemented with an EPS network or combination of several types of EPS networks, such as for example a 4G EPS network, a 5G EPS network, or a combination of networks using a 4G EPS network and/or a 5G EPS network. Similarly, depending on the chosen embodiment, the proposed methods and systems may be implemented with a packet data communication network (“Packet Data Network,” or PDN), such as for example one or more interconnected IP networks, or a combination of several types of data communication networks comprising a packet data communication network.

Depending on the embodiment, the communication link between terminal equipment (2a, 2b, 2c, 2d, 2e) and the concentrator (3) may comprise one or more communication link types, such as for example a radio communication link, a wired communication link and/or an optical communication link (for example one or more optical fibers). Each communication link may be operated according to one or more data communication protocols corresponding to the link type. For example, in one or more embodiments, the communication link between terminal equipment (2a, 2b, 2c, 2d, 2e) and the concentrator (3) may comprise a radio communication link for data communication and a Wi-Fi (“Wireless Fidelity”) type network, operating according to one or more IEEE 802.11 standards, and/or a data communication link by power-line communication, for example 3G CPL (third generation powerline communication). Thus, the proposed methods and systems are not limited to one network type or architecture or to one communication link type for data communication between terminal equipment (2a, 2b, 2c, 2d, 2e) and a concentrator node (3) connected to the EPS network (4).

Depending on the embodiment, the proposed method may be implemented in order to authenticate managed equipment which may, according to the case, be concentrator equipment of the type of that (3) shown on FIG. 1 and/or terminal equipment (2a, 2b, 2c, 2d, 2e) (for example IED equipment) connected to an EPS network which may be via a concentrator (3), as shown on FIG. 1. Depending on the embodiment, equipment for which the authentication may be managed by the proposed method may be terminal equipment, such as independent equipment placed in a building (e.g. a residence), such as for example an electric meter counting a quantity of electric flow or sub-flow, or equipment from a larger set, housed in a source substation, for example, in a residential neighborhood for example or in a rural or semi-rural area, and serving to drive electrical measurement or security devices such as switches or circuit breakers. Terminal equipment may for example be an IED type equipment.

The proposed method draws an advantage from the use of the security function in EPS type networks provided for securing data communication within the network.

An implementation example of a security function in an EPS type network is described below, in an EPS network like the one illustrated in FIG. 1, in one or more embodiments.

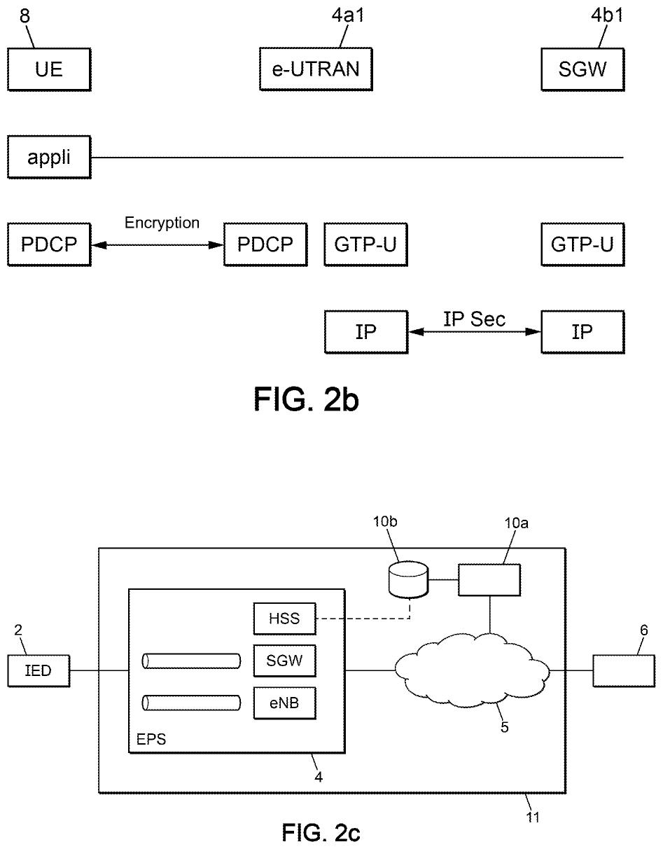

FIG. 2a shows a network architecture example for the implementation of the proposed method according to one or more embodiments.

Referring to FIG. 2a, an EPS network (4) comprises an access network (4a) connected to a core network (4b). In one or more embodiments, the access network may comprise one or more 4G and/or 4G+ radio access networks, including for example an LTE type radio access network (EUTRAN, for “Evolved UMTS Terrestrial Radio Access Network”), one or more 3G and/or 3G+ radio access networks, including for example a UMTS type radio access network (UTRAN, for “UMTS Terrestrial Radio Access Network”), or one or more 2G radio access networks, including for example a GSM (“Global System for Mobile communication”), GPRS (“General Packet Radio Service”) and/or EDGE (“Enhanced Data Rates for Global Evolution”) (such as a GERAN network, for “GSM EDGE Radio Access Network”), or a combination of these different types of radio access network.

In one or more embodiments, the core network (4b) may be EPC type (“Evolved Packet Core”), and be connected to one or more access networks, on the one hand, and to one or more external data communication networks (9), which may possibly comprise one or more IMS networks (for “IP Multimedia Subsystem”) (9a) for supplying IP services by the core network operator (4b), on the other hand. One or more pieces of user equipment (8), such as for example the concentrator (3) and/or one or more units of terminal equipment (2a, 2b, 2c, 2d, 2e) from FIG. 1 are configured for data communication by radio link via one or more radio access networks (4a).

The EPC core network (4b) may include the following functional entities: a mobility management function for user equipment in the EPS network (MME, for “Mobility Management Entity”), a 2G/3G core network service gateway function (SGSN, for “Serving Gateway Support Node”), an LTE service gateway function (SGW, for “Serving Gateway”), a gateway function towards external networks (PDN-GW, for “Packet Data Network—Gateway”), and the user and subscriber database function (HSS, for “Home Subscriber Server”).

The interface between the UTRAN and the SGSN may be of the Iu type specified by the 3GPP, the interface between the SGSN and the MME may be of the S3 type specified by the 3GPP, the interface for the user plane (data traffic) between the SGW and the E-UTRAN may be of the S1-U type specified by the 3GPP, the interface for the control plane (signaling traffic) between the MME and the E-UTRAN may be of the S1-C type specified by the 3GPP, the interface between the MME and the HSS may be of the S6A specified by the 3GPP, the interface between the SGSN and the SGW may be of the S4 type specified by the 3GPP, the interface between the SGW and the PDN-GW may be of the S5 type specified by 3GPP, the interface for the control plane between the MME and SGW may be of the S11 type specified by the 3GPP, and the interface between the PDN-GW and the external networks may be of the SGi type specified by the 3GPP.

In the user plane (data traffic), the user data sent by the E-UTRAN access network therefore meet in the SGW gateway before being directed to the PDN-GW and then towards the external networks (9).

Reference may be made to the 3GPP technical specifications for a detailed description of these functional entities, these interfaces, and the protocols which may be used for their implementation. The person skilled in the art will however understand that the methods, systems and devices proposed in the present subject disclosure are not limited to a particular access network type (for example a particular 3GPP access network type or a particular 3GPP network generation), or to a particular PDN network type (or a particular IP network type), but can be implemented with any type of access network configured for using a first security function, in particular for access to the network, and any type of data communication network configured for using a second security function, in particular for access to the network. In particular in one or more embodiments, the access network may be a Wi-Fi type configured in “ad hoc” network mode, which has the advantage of providing an EAP type authentication (“Extensible Authentication Protocol”), according to the RFC 41187 technical specification. The 3GPP initial authentication mechanisms (called “AKA,” for “Authentication and Key Agreement”) were in fact adapted for making them compatible with the set of IEEE 802.11 standards relating to local wireless networks (Wi-Fi), which led to the EAP-AKA authentication specification, and an EAP authentication method which can be used by wireless network user terminals (such as for example the UMTS and CDMA2000 3G networks and 4G such as LTE). The EAP-AKA authentication method allows in particular equipment provided with a SIM module to authenticate over IEEE-802 links not with a simple password, but with SIM module security elements with which they are provided. Its implementation means in general that the radio access point is connected to a RADIUS server (“Remote Authentication Dial-In User Service”) which in turn has access to the HSS.

FIG. 2b shows a security function example in an EPS network for the protection of the user plane.

Referring to FIG. 2b, user data are sent between user equipment (8) and an SGW (4b1) gateway of an EPC core network via an E-UTRAN (4a1) type radio access network. FIG. 2b further shows examples of protocol stacks (according to a protocol layer architecture) which can be used by UE (“User Equipment”) (8), the nodes of the E-UTRAN (4a1) network (typically of the base station type, or “eNB”), and the SGW (4b1) gateway. The data are sent by the application layer “app,” which in the illustration from FIG. 2b exists only in the user equipment, to a lower layer of the packet forming protocol, the PDCP protocol in the example shown. The protocol layers below the transport level are not further shown on FIG. 2b.

As shown on FIG. 2b, a first security function is used for securing data communication over the air interface between the PDCP entity of the UE (8) and the corresponding entity of the E-UTRAN (4a1) node with which the UE (8) exchanges data over the air interface. A second security function (called “IP security function”) is used for securing the IP connection between the IP layer implemented by a node of the E-UTRAN (4a1) and the IP layer implemented by the SGW (4b1) for data communication of the “appli” application layer of the UE (8). This IP security function is implemented by using the IPsec protocol (“Internet Protocol Security”), described in the specification RFC 2401, which allows, while operating in an IP packet encapsulation mode called “tunneling,” establishing a secured communication between entities by creating tunnels between these entities.

The ISO model levels 1 and 2 protocol layers, not shown on FIG. 2b, can also use a security function.

Typically three data communication security levels can therefore be found for the protection of the user plane between user equipment (8) and an SGW (4b1) of the core network EPC, for example through an authentication, encryption and/or integrity verification on each of these three levels. Referring to FIG. 1, communication between an IED equipment and an application server (6) using an EPS network (4) can use these three levels of communication security for the data communication segment used between the IED equipment and the EPS network (4) which is used.

The security functions used in the EPS network are typically, for the most part, based on mechanisms that use secret keys known by the HSS in the EPS network. This field of cryptography is generally referred to as symmetric cryptography, or may sometimes also be referred to as “secret key cryptography.” Symmetric cryptography uses the same key for encrypting and decrypting messages to be protected. The security of the exchange of messages or data is provided by the fact that only the sender and recipient know the key, which is therefore secret. This type of cryptography has the merit of having been brought along in wireless telecommunications networks, and in particular 3GPP networks, from technological generation to technological generation, and therefore allows the benefit from a large number of standardized security functions. Thus, providing equipment with a SIM module (“Subscriber Identity Module”; for example, in the form of a SIM card or an eSIM module) serves to implement functions provided for by the 3GPP standards in particular those for cybersecurity which include authentication, attachment to the network and integrity encryption. Since encryption occurs very early in the establishment of the protocols, even the malicious reading of identifiers is thus made complicated.

In one or more embodiments, the proposed method may be implemented for authenticating managed equipment provided with a first security module, called “EPS security module,” comprising encryption key type security data for implementation of one or more security functions used in the EPS type communication network to which the managed equipment comes to be connected for exchanging data with an application server. In one or more embodiments, the encryption key security data for the EPS security module may be of the secret key type, for example incorporated in a SIM module (materialized or dematerialized), or a module with embedded security functions similar to those of a SIM module. For example, the security module may be a card (“UICC” or “Universal Integrated Circuit Card”) comprising security data and configured for implementing a SIM application (materialized or dematerialized), such as specified in the 3GPP specification TS 51.011 for GSM type networks, or a USIM application, defined in the 3GPP specifications TS 31.102 and TS 21.111 for GSM, EDGE, UMTS and/or LTE networks depending on the selected implementation.

Again referring to FIG. 1, in one or more embodiments, the managed equipment (2a-2e and/or 3), whose authentication for access to the application server (6) may be managed by the implementation of the proposed method, exchanges data with an application server through an EPS type network (4) and a packet communication network (9), such as for example an IP network, in the context of one or more service delivery applications. Access to such applications may typically be secured by security functions, for example using asymmetric cryptography mechanisms and data communications security protocols on the Internet, such as, for example, SSL (“Secure Socket Layer”) and/or TLS (“Transport Layer Security”) protocols.

In one or more embodiments, data communication in the IP network may be secured by a public and private key encryption mechanism, used for example for the encryption of data passing over the network and/or for authenticating a user. The encryption of data may be performed by using the public key of the recipient, with the recipient using the private key thereof for decryption of the data. Authentication of the data sender may be performed by data encryption by the sender by using the private key thereof, and the recipient using the private key of the sender for decrypting data.

In one or more embodiments, securing data exchanges by asymmetric cryptography may use digital certificates which contain the public key of the entity associated with the certificate for encrypting or authenticating communication links without prior sharing of a mutual key. A public key infrastructure (“PKI”) may be used for managing authentication and digital signing of one or more functional entities or of one or more equipment units in the network.

In one or more embodiments, one or more Web or IP type applications, deployed by service provider companies operating a network comprising one or more IP network type packet data communications networks may be executed in client-server mode in the managed equipment. Advantageously, data processing applications (“data analytics”), supervision applications (for example maintenance, and downloading, etc.), and/or commercial applications (for example of the “block chain” type) may for example be implemented within one or more application servers configured for performing measurements or calculations locally in order to avoid overloading the networks in terms of information forwarding.

In one or more embodiments, the secured implementation of these applications by a service operator may reside in the Internet world on an infrastructure for management of PKI type keys configured for managing the public keys that it distributes to equipment, generally in the form of certificates. Peer managing means deploying procedures with which to generate, allocate, store, destroy, change, and revoke public keys with which to proceed with the implementation of application-level authentication, encryption and integrity functions by public key mechanisms such as for example X.509 certificate management mechanisms. For example, a service operator, implementing for example “professional” driving functions for its network (for example an energy distribution network), may be the owner of an EPS or equivalent type network infrastructure (such as for example any network conforming to the standards specified by the 3GPP organization, in particular on the access network segment and into the access gateway (for example an SGW) to the Internet network or more specifically to a PDN network (for example an IP network)). Several scenarios are conceivable in this regard: for example, the operator may use the IP network, with which it will get guarantees in terms of latency, bandwidth (governed by the Internet quality of service) but also redundancy. The operator may also use, as applicable, its fiber-optic network control center (“SCADA,” “Supervisory Control and Data Acquisition”) and/or its own lines.

In one or more embodiments, it is proposed to provide a managed equipment with a second security module, called “IP security module,” comprising encryption key type security data for implementing one or more security functions used in the IP data communications network(s) in which data exchanged by the managed equipment and an application server of an IP data communications network pass. In one or more embodiments, security data of the encryption key type of the IP security module may be of the public-key type, for example in the form of a certificate, or a certificate equivalent.

In one or more embodiments, it is thus proposed to provide a managed equipment with an IP security module and an EPS security module. For example, a managed equipment may incorporate secret-key type data, for example within a SIM module for connection with an EPS network, and public-key type data for connection with the application level of IP type service networks.

FIG. 2c shows a system architecture example for the implementation of the proposed method according to one or more embodiments.

Referring to FIG. 2c, an IED node (2) is connected to an EPS type communication network (4) interconnected with a data communication network (5). The network comprising the EPS type telecommunication network (4) connected to a data communication network (5) may correspond, in one or more embodiments, to a network (11) operated by a service provider company, which may for example, according to the scenarios, be the owner or renter of the network infrastructure. The network operator may provide to subscribers to its service an IED equipment of the type illustrated by FIG. 2c configured for performing data communication with an application server (6) (for example a professional application server for managing the electric distribution network) connected to the network (11) secured according to the proposed method, for example in the context of service delivery by the company to its clients.

In one or more embodiments, the IED node (2) can be provided with an IP security module and an EPS security module (for example a SIM module) as described above.

The proposed method can be implemented, in one or more embodiments, by an authentication management unit, which may itself be implemented within a node (10a) of the network (11), called “Smartgrid server” or “Smartgrid GW.”

In one or more embodiments, the Smartgrid GW node (10a) may comprise, or, depending on the embodiment, be connected to, a key management infrastructure (not shown on the figure), called “PKI-Energy,” or “PKI-E,” configured for managing certificates intended for the nodes (IED, SM, etc.) of the network (11). Thus, the Smartgrid GW node (10a) may be connected to the data network (5), and the authentication management unit according to the proposed method may be configured for communicating with a security function (for example the “PKI-E” key management infrastructure) used for securing data communication for the data communication network (5). This communication link may advantageously itself be secured, for example by using an architecture in which the authentication management unit and the security function for the network (5) are co-located, as described above.

In one or more embodiments, the Smartgrid GW node (10a) may further be connected to the EPS type telecommunication network (4), for example to the first server of the EPS network (4) encountered by the traffic, for example by a secured tunnel. For example, referring to FIG. 2a, the Smartgrid GW node (10a) may be connected to the SGW Gateway in one or more embodiments.

The Smartgrid GW node (10a) may thus be configured, in one or more embodiments, for providing, in addition to an authentication management function for access to the application server (6) according to the proposed protocol, a security function for securing the data communication in the data communication network (5). In particular, the Smartgrid GW node (10a) may be configured for managing as an application the certificates intended for the nodes (e.g. IED, SM, etc.) and for providing secured applications with cryptographic hardware necessary for the creation of secured links. Note that then, a certificate that is provided to a node of the network would have the benefit of a triple encryption/integrity (encapsulated three times) between the equipment and the “PKI-Energy” infrastructure.

In one or more embodiments, the Smartgrid GW node (10a) may therefore be configured for providing an authentication management function according to the proposed method implemented within an authentication management unit, and for this purpose may be connected to the data communication network (5) and the access network (4).

Further, in one or more embodiments, the “Smartgrid GW” node (10a) and the HSS for the EPS network (4) may be configured for communicating with a database, sometimes referred to herein as “consistency database”, configured with pairings of identifiers corresponding to the IED node (2) (for example IMSI—public key pairs as described below), possibly by means of a dedicated server, sometimes referred to as “consistency server” (not shown on the figure). For example, the “Smartgrid GW” node and the HSS node of the EPS network (4) may be configured for connecting to the consistency database, querying this database and/or receiving data from the server (for example alerts about fraudulent access requests or histories of access requests to the application server). Advantageously this makes it possible to have access network and PDN network security functions communicate, for example via the consistency database or server, for access control to the application server according to the proposed method. Further, the consistency database may then inform the HSS, for example, of the fraud history of authentication attempts from malevolent managed equipment on the data network (5), in order to block authentication on the access network (4). Depending on the chosen embodiment, the authentication management unit (Smartgrid GW) and the consistency server may be implemented in a plurality of distinct nodes of the network (11) or in a single node. Further, the Smartgrid GW node (10a) may be configured for embedding an authentication management function for access to the application server according to the proposed method, and for further embedding an authentication server for the second network (data communication network (5)) and/or a consistency server for access to the database. The person skilled in the art will understand that the proposed systems, equipment and units are not limited to a specific architecture for implementation of the proposed method.

Methods for managing authentication of an equipment according one or more embodiments in a system such as illustrated by FIG. 1 are described hereinafter.

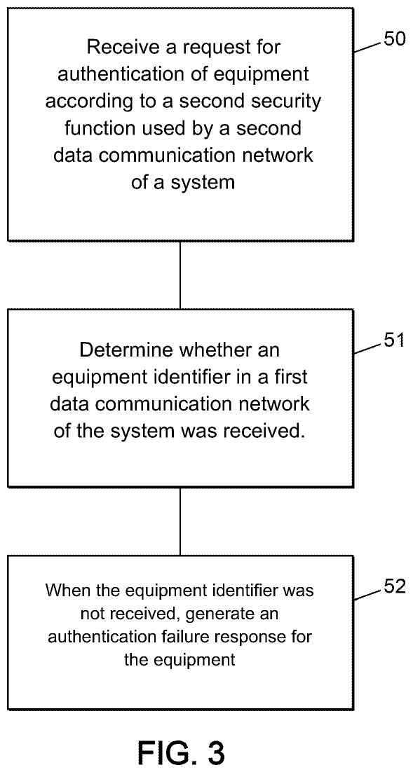

Shown on FIG. 3 is a data communication system comprising a first data communication network, such as for example an EPS type data communication network, configured for using a first security function for securing data communication within the first network, such as for example a symmetric encryption infrastructure in the case of an EPS network.

This first data communication network can be operatively coupled to a second data communication network, such as for example an IP network type data communication network configured for using a second security function for securing data communication within the second network, such as for example a PKI type asymmetric encryption infrastructure in the case of an IP network. The first and second data communications networks are thus interconnected for the exchange of data, in particular for access requests sent by a managed equipment for access to an application server via the first and second networks. For example, the first network will typically be a wireless access network (for example 3GPP type) to which the managed equipment is connected for sending an access request to an application server connected to the second network, which may typically be a PDN network (for example an IP network). In one or more embodiments, serving an access request from the managed equipment will involve the use of the first and/or second security functions used respectively by the first and second networks for authentication, and therefore to authentication requests from the managed equipment according to a first and/or second security function(s).

In one or more embodiments, managing the authentication of an equipment of the data communication system for the exchange of data between the equipment and an application server of the system may comprise, in an authentication management unit implemented in a node of the second communication network, receiving (50) an authentication request from the equipment according to the second security function for access to the application server.

The authentication management unit may be configured for, further to receiving the authentication request from the equipment, determining (51) whether an identifier of the equipment in the first communication network was received further to receiving another authentication request for the equipment according to the first security function. In the case where the first data communication network is EPS type (for example GSM, GPRS, EDGE, UMTS, HSPA, LTE, LTE-A and/or 5G type 3GPP network), the identifier of the equipment that is the subject of the determination (51) may for example be IMSI type (“International Mobile Subscriber Identity”), or any other unique identifier used by the equipment for access to the EPS network.

The authentication management unit may further be configured for generating (52) an authentication failure response for the equipment when the identifier of the equipment was not received.

The proposed method in that way advantageously uses two security functions combined respectively with first and second data communications networks of a data communication system in order to manage authentication of an equipment of the system for securing the exchange of data with the application server of the system. The proposed method serves in particular advantageously to defend against security attacks coming from fraudulent or pirated equipment consisting of authentication requests according to a security function of the second network. Indeed, in the nominal authentication mode for exchanging data between equipment for the system and an application server of the second network, the equipment authenticates itself according to a security function of the first network in order to establish a communication link in the first network, as the data to be exchanged with the application server may have to go through the first communication network. Since the authentication of the equipment according to the security function of the first network leads the equipment to provide an identifier in the first network, the combination of the security functions respectively associated with the first and second data communication networks may comprise the centralization of the processing of authentication requests (according to the first and second security functions) within a single security entity, for example implemented in an authentication management unit of the system which is a node of the second communication network. Thus a fraudulent authentication request according to the second security function coming from a suspicious equipment may be detected and rejected when the equipment has not previously provided the security entity with an identifier for the first communication network in the context of an authentication request according to the first security function.

In one or more embodiments, the management of authentication of an equipment of the data communication system for the exchange of data between the equipment and the application server may comprise, at the authentication management unit of the system, receiving (50) an authentication request from the equipment according to the first security function for access to the application server, wherein the request uses an identifier of the equipment in the first communication network.

Referring to FIG. 2c, the “Smartgrid GW” authentication management unit (10a) may be configured for receiving authentication requests from the IED node (2) according to the security function implemented by the EPS network (4) performed by the node (2) in order to get access to the server (6) by means of a connection to the EPS network (4). In one or more embodiments, the authentication requests from the IED equipment (2) according to the second security function implemented by the EPS network (4) may correspond to an Identifier of the IED equipment (2) used for the request thereof, such as for example an IMSI subscriber identifier for the IED equipment (2) when said equipment is provided with a SIM type subscriber identification module. The “Smartgrid GW” authentication management unit (10a) may in that way be configured for obtaining from the IED equipment (2) the identifier used for formulating the authentication request in the EPS network (4), and for storing this identifier in order to make the determination of identifier reception in the first network further to receiving an authentication request from the IED equipment (2) in the second network, as described above.

In one or more embodiments, the proposed system may further comprise a database preconfigured with a correspondence between the Identifier of the IED equipment in the first network and a security element of the second security function for authentication requests according to the second function addressed to the second network by the equipment.

The proposed method may then comprise, in one or more embodiments, sending to the consistency database a request for verification of recording of the received identifier in the database, the request comprising the received identifier.

Referring to FIG. 2c, the proposed system may comprise, in one or more embodiments, the consistency database (10b), and the “Smartgrid GW” authentication management unit (10a) may be configured to query the consistency database (10b) further to receiving an authentication request according to the security function implemented by the EPS network (4) and/or an authentication request according to the security function implemented by the PDN network (5).

The “Smartgrid GW” authentication management unit (10a) may thus query the consistency database (10b) with the identifier of the IED equipment (2) received by means of authentication request from the IED equipment (2) in the EPS network (4), in order to verify that that identifier is indeed preconfigured in the consistency database (10b).

This aspect of the proposed method advantageously serves to defend against attacks from equipment which manage to fraudulently send an authentication request in the EPS (4) network with a stolen identifier. The consistency verification performed with the consistency database which is configured with nonfraudulent equipment identifiers serves in fact to reject authentication requests coming from equipment which do not have an identifier already stored in the consistency database.

For example, the consistency database (10b) may comprise, by pre-configuration for each IED equipment managed according to the proposed method, an identifier of the IED equipment (2), such as for example an IMSI subscriber identifier of the IED equipment (2) matched with a security element of the security function implemented by the PDN network (5). This security element may for example be a public key, in the scenarios where a public and private key encryption mechanism is used for authentication of equipment in the PDN network (5), or a digital certificate containing a public key issued by a PKI infrastructure used for managing authentication in the PDN network (5). The “Smartgrid GW” authentication management unit (10a) may thus be configured for querying the consistency database (10b) with the IMSI of the IED equipment (2) received by means of an authentication request from the IED equipment (2) in the EPS network (4) in order to verify that that IMSI is preconfigured in the consistency database (10b), corresponding to a public key for the IED equipment (2).

In one or more embodiments, the proposed method may further comprise the management of various authentication failure cases of the IED equipment. These failure cases may in particular include the “Smartgrid GW” authentication management unit (10a) receiving a response that a record of the received identifier is not present in the consistency database (for example the IMSI identifier received by the “Smartgrid GW” authentication management unit (10a) is not recorded), and/or the “Smartgrid GW” authentication management unit (10a) receiving a response that indicates an anomaly relative to one or more preceding authentication queries for the equipment according to the first security function in the first communication network and/or according to the second security function in the second communication network. For example, in one or more embodiments, a history relating to the preceding authentication requests presented by the IED equipment may be stored, for example in the consistency database, in connection with the IED equipment, in order to be able to confront a new authentication request received for the IED equipment with this history. In one or more embodiments, the authentication history for an IED equipment may record any anomaly relating to a previous authentication request, whether that anomaly relates to an authentication according to the EPS network security function and/or an authentication according to the PDN network security function. Upon receiving an authentication request for an IED equipment, the consistency database can thus be queried for determining whether the IED equipment history contains at least one anomaly, or for determining the number of anomalies recorded in the history for this IED equipment.

Various authentication failure management criteria may be applied depending on the embodiment, and an IED equipment authentication failure response may be generated if one or more of these criteria are met. For example, an authentication failure response may be generated when the number of authentication anomalies contained in the authentication history for the IED equipment is greater than a preset threshold (which may be configured to the value 0). For example, an authentication failure response may be generated when the number of authentication anomalies recorded in the authentication history for the IED equipment for the EPS network security function or the PDN network security function is greater than a respective preset threshold (the respective thresholds may be configured to different values, and one of the thresholds may be configured to the value 0 (for one of the functions), while the other may be configured to a nonzero value (for the other function)).

Thus, the authentication security for the IED equipment may advantageously be improved by generating an authentication failure response based on the lack of record relating to the IED equipment in the consistency database, and/or because of an authentication history for the IED equipment, which may also be stored in the consistency database, relating to one and/or the other of the security functions used by the two networks used for the exchange of data between the IED equipment and the application server.

A database, such as the consistency database described above, may be used, in one or more embodiments, to strengthen the security of the authentication in the second network, which may typically be a PDN network, for example of the IP type.

In one or more embodiments, a database preconfigured with the correspondence between an identifier of the IED equipment in the first network (for example an IMSI identifier for the IED equipment in a 3GPP network (for example 5G)) and a security element of the security function for the second network (for example a public key used for authentication in the PDN network (for example IP)) for authentication requests for the IED equipment according to the second function addressed to the second network, such as the consistency database described above and illustrated by FIG. 2c may thus be used for validating or invalidating an authentication request received for an IED equipment. This processing of an authentication request received for an IED equipment may comprise, when the authentication request relates to an authentication in the second network and uses the security element, sending to the database a request for verification of recording of the received identifier corresponding to the received security element in the database, wherein the request comprises the received identifier and the received security element.

Thus, in one or more embodiments, referring to FIG. 2c, the “Smartgrid GW” authentication management unit (10a) may be configured for querying the consistency database (10b), on the basis of a received authentication request from the IED equipment (2) in the PDN network (5) and which will have been preceded with an IED equipment (2) authentication request in the EPS network (4). The “Smartgrid GW” authentication management unit (10a) may be configured to obtain, on the basis of the authentication request from the IED equipment (2) in the EPS network (4), an identifier for the IED equipment in the EPS network (4) (for example an IMSI identifier), and on the basis of the authentication request from the IED equipment (2) in the PDN network (5), a security element from the security function implemented for the authentication in the PDN network (5). Thus, the “Smartgrid GW” authentication management unit (10a) may be configured for querying the consistency database (10b) in order to determine whether the consistency database contains a record of the identifier of the IED equipment in the EPS network (4) corresponding to the security element for the authentication in the PDN network (5). For example, the “Smartgrid GW” authentication management unit (10a) may query the consistency database (10b) in order to confirm that it contains a record of the IMSI of the IED equipment (2) corresponding to the public key (for example the certificate) presented by the IED equipment (2) for authenticating on the PDN network (5).

In the scenarios where querying the consistency database leads to determining that it contains a record of the identifier of the IED equipment in the EPS network (4) corresponding to the security element for the authentication in the PDN network (5), an authentication success response for the IED equipment may be generated for confirming the authentication of the equipment. Conversely, in the scenarios where querying the consistency database leads to determining that it does not contain a record of the identifier of the IED equipment in the EPS network (4) corresponding to the security element for the authentication in the PDN network (5), an authentication failure response for the IED equipment may be generated for invalidating or refusing the authentication of the IED equipment. Referring to FIG. 2c, querying the consistency database (10b) may be performed by the “Smartgrid GW” authentication management unit (10a), and the authentication success or authentication failure response for the IED equipment (2) following querying the consistency database (10b) may be generated by the “Smartgrid GW” authentication management unit (10a). This authentication response may be transmitted, in one or more embodiments, to the equipment originating the request, and may additionally be entered in the consistency database for building the history of authentication requests for the equipment.

In one or more embodiments, the network node configured for implementing the proposed method may be configured for, in one or more scenarios described in the present subject disclosure in which it is determined that an authentication success and/or failure response must be generated following an authentication request for the IED equipment (referring to the architecture from FIG. 2c, authentication request in the EPS network (4) or authentication request in the PDN network (5) following an authentication request in the EPS network (4)), sending to the consistency database a request for recording the result (success or failure) of the authentication request for the IED equipment (2). In one or more embodiments, this request for recording the result may only be sent in the case where the result is a failure or in only certain cases of failure. Advantageously this makes it possible to build an authentication history for the equipment in the system, a history which may be used for improving the authentication security of the equipment in the system, as described above.

For example, referring to FIG. 2c, the “Smartgrid GW” authentication management unit (10a) may be configured for, in the cases where said unit determines an authentication failure of the IED equipment (2), sending to the consistency database (10b) a request for recording the authentication failure of the IED equipment (2) corresponding to the IED identifier (2) in the EPS network (4) used for the authentication request for the IED equipment (2) in the EPS network (4) and/or with the security element for authentication in the PDN network (5) used for the authentication request from the IED equipment (2) in the PDN network (5).

In one or more embodiments, the authentication of an equipment (for example an IED equipment) may use a timer, which would be initialized to a preset duration (Tmax) and triggered (started) upon receiving an authentication request from the equipment according to the security function of the first communication network. For example, referring to the architecture from FIG. 2c, a timer may be triggered upon receiving an authentication request from IED equipment (2) in the EPS network (4), giving rise to receiving an identifier of the IED equipment (2) in this network (for example in IMSI identifier).

It may then be determined, when no authentication request for the equipment according to the second security function of the second communication network is received before the expiration of the timer, that the first authentication request is in fact an attack, which may lead to generating an authentication failure response for the equipment.

These embodiments will make it possible to protect the system against attacks by using only the authentication function in the first network, without the need to provide the elements necessary to an authentication in the second network, by advantageously combining the two authentication functions used respectively in the first and the second network. Indeed, a nonfraudulent equipment will issue a first authentication request in the first network, for the wireless access network part for data exchanges with the application server. If it is accepted, this first request will lead to a second authentication request, in the second network, for the application part of the data exchanges with the application server, which will be issued in a limited time interval following the first authentication request. Therefore, an IED equipment (2) that issues one or more authentication request(s) in the second network in a lapse of time greater than a predetermined threshold after an authentication request in the first network, may be considered fraudulent and the authentication requests as security attacks. The use of a timer for controlling the time elapsed between the authentication request in the first network and the authentication request in the second network serves advantageously to defend against this type of attack.

In one or more embodiments, the IED equipment may be provided with an initial security element, such as for example a security element configured by the manufacturer during manufacturing of the IED equipment. This security element may for example be a public key of the manufacturer of the IED equipment, in the form of a certificate which can be used for authentication for access to the application server on the second data communication network (for example on the PDN network).

The proposed method may comprise, at the authentication management unit, receiving an authentication request from the IED equipment according to the security function of the second communication network, wherein the authentication request uses the initial security element. The authentication management unit can then perform the authentication verifications provided for access to the application server, including those proposed, and in case of success generate an authentication success response for the equipment in order to authorize access of the equipment to the application server.

In one or more embodiments, the authentication management unit may further be configured for, upon receiving a message from the application server indicating that the equipment is recorded in the application server by using a secured connection between the equipment and the application server following the authentication success of the equipment, obtaining an operator security element, and transmitting this operator security element to the application server for transmission to the IED equipment by using the secured connection.

In the scenarios where the authentication management unit is configured for using a consistency database, the authentication management unit can further be configured for sending to the database a request to update the initial security element with the operator security element.

Thus, for example, when the IED equipment is natively provided with a certificate by the equipment manufacturer (such certificate may be referred to in the following as an “OEM” certificate (“Original Equipment Manufacturer”)), it uses this “OEM” certificate for authenticating with the IP network authentication server to which the application server is connected, which knows the public key of the equipment manufacturer. The proposed authentication management unit may also implement the proposed method for validating or invalidating authentication of the IED equipment with the “OEM” certificate thereof. When the authentication succeeds, a secured tunnel can be opened between the IED equipment and the application server.

The authentication server may then send to the IED equipment, by this secured tunnel, an “operator” certificate signed by the operator, possibly via the authentication management unit, so that the IED equipment updates the certificate thereof by replacing the “OEM” certificate with the “operator” certificate.

The authentication management unit may further be configured for obtaining this new “operator” certificate, and sending it to the consistency database for updating the record relating to the IED equipment, as applicable, so that this updated record can be used for subsequent access requests to the application server coming from the IED equipment.

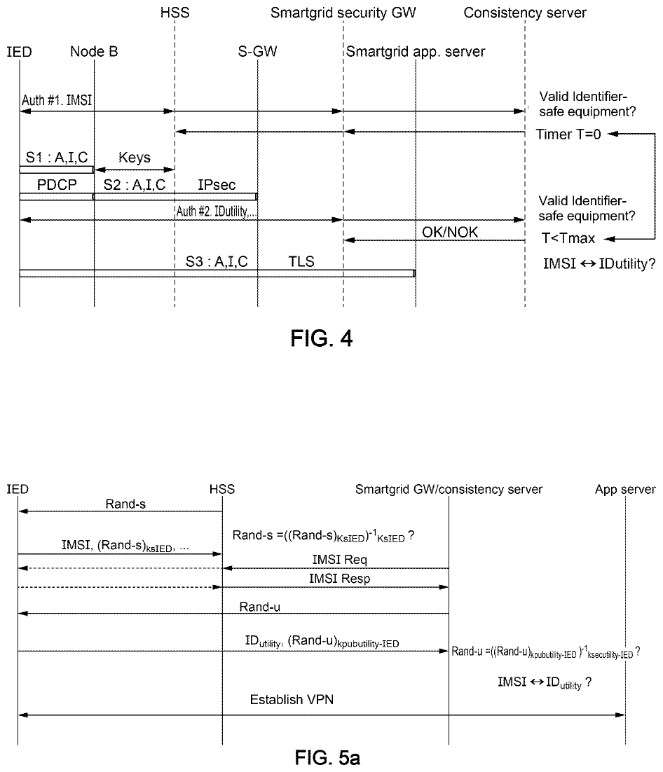

FIG. 4 is a diagram showing a double authentication example according to one or more embodiments.

The sequencing example shown on FIG. 4 may be implemented in the nonlimiting architecture example shown on FIG. 2c, to which reference will be made for the description of FIG. 4.

Shown on FIG. 4 is an example of double authentication of an IED equipment with an EPS network comprising a radio access network comprising a Node-B and a core network comprising an HSS function and an S-GW function, and with a PDN network, for data communication between the IED equipment and an application server on the PDN network. The proposed method shown on FIG. 4 uses a “Smartgrid GW security” server providing an authentication management function, for example according to one or more of the embodiments described above, and a consistency management server (“consistency server”) provided with a consistency database, for example according to one or more of the embodiments described above.

The communication links between the IED equipment and the Node-B are wireless communication links, whereas the communication links between the Node B and the “Smartgrid app server” application server are wired communication links. Further, the communication links between the IED equipment and the S-GW are implemented in the access network (EPS network (4) in FIG. 2c), whereas the communication links between the S-GW and the “Smartgrid app server” application server are implemented in a data communication network (PDN network (5) in FIG. 2c).

The IED equipment sends a first identification request (“Auth #1, IMSI, . . . ”) in the access network to the HSS server of this network. The identifier of the IED equipment in the access network used for this first authentication request (for example an IMSI identifier) is then sent by the HSS to a consistency management server, directly or via the “Smartgrid security GW” server. The consistency management server verifies (“Valid identifier—safe equipment?”) if the consistency database contains a record with the identifier of the IED equipment in the access network used for the first authentication request. If the identifier is recorded in the consistency database, the equipment is considered as safe, and the authentication process continues. In the opposite case (not shown on the figure), if the identifier is not recorded in the consistency database, the equipment is considered as fraudulent and the request as an attack, and the authentication process is stopped, possibly with updating of the consistency database with the identifier used by the fraudulent equipment. Depending upon the embodiment, the response relating to the validity of the identifier may be transmitted by the consistency management server to a “Smartgrid security GW” server and the authentication success or failure response be sent by the “Smartgrid security GW” server to the HSS, or the authentication success or failure response may be generated by the consistency server and relayed by the “Smartgrid security GW” to the HSS.

In one or more embodiments, a timer may be triggered (“Timer T=T₀”) upon determination that the identifier is recorded in the consistency database and therefore that the equipment is safe. In other embodiments, the timer may be triggered upon receiving the identifier. Further, depending on the embodiment, the timer can be managed by the consistency management server or by the “Smartgrid security GW.”

The security function of the access network may be implemented for, upon success of the first authentication request, securing the data exchanged with the network by the IED equipment: a security tunnel (S1) (Authentication, Integrity and/or Encryption) is established for the data communications over the air interface between the IED and the Node-B, and then security elements are exchanged with the HSS for implementation of a security tunnel (Authentication, Integrity and/or Encryption), for example according to the PDCP protocol, between the IED equipment and the Node-B, and a security tunnel S2 (Authentication, Integrity and/or Encryption), for example according to the IPsec protocol, for data communication between the Node-B and the S-GW.

Once the data communication in the access network (EPS) is secured with the security functions used by the access network, the IED equipment sends a second authentication request (“Auth #2, IDutility, . . . ”) in the second network to the “Smartgrid security GW” server. An identifier (IDutility) for the IED equipment in the second network used for this second authentication request (for example contained in a certificate with which the IED equipment is preconfigured) is provided to the “Smartgrid security GW” server with the request, and then transmitted to the consistency management server. In the embodiments where the “IDutility” identifier is contained in a certificate, this certificate may contain a temper-resistant association between an identity and a public key. The “IDutility” identifier can then be the identity or the public key on a one-to-one basis. When the identifier used is the public key, it is a security element. In this respect, in some systems, a mail address type identifier can be chosen as a public key, and the system configured such that a private key can be deduced from this address. The consistency management server verifies (“Valid identifier—safe equipment?”) if the consistency database contains a record with the identifier of the IED equipment in the access network used for the first authentication request corresponding to the security element. If the identifier and security element pair is recorded in the consistency database, the equipment is considered as safe, and the authentication process considered successfully complete. In the opposite case (not shown on the figure), if the identifier and security element pair is not recorded in the consistency database, the equipment is considered as fraudulent and the request as an attack, and the authentication process fails, possibly with updating of the consistency database with the identifier and the security element used by the fraudulent equipment. Depending upon the embodiment, the response relating to the validity of the request may be transmitted by the consistency management server to the “Smartgrid security GW” server and the authentication success or failure be sent by the “Smartgrid security GW” server to the HSS or the authentication success or failure response be generated by the consistency server and relayed by the “Smartgrid security GW” to the IED equipment.

Upon success of the second authentication request, the security function of the second network is implemented for securing the data exchange by the IED equipment with the “Smartgrid app server” application server: a security tunnel (S3) (Authentication, Integrity and/or Encryption) is established, for example according to the TLS protocol, for data communication between the IED equipment and the “Smartgrid app server” application server.

In the embodiments in which a timer was triggered (“Timer T=T₀”) upon determination that the identifier is recorded in the consistency database, and therefore that the equipment is safe, it can be verified that this timer had not expired before it was determined that the identifier and security element pair was recorded in the consistency database, and therefore that the equipment is safe. If it is determined that the timer had already expired, it may be considered that the two authentication requests, even though they would both be valid, came from fraudulent equipment and the authentication may consequently be refused. In the opposite case, the defense against attacks using the timer may be considered as not having given rise to the identification of an attack.

Various use cases can therefore be envisaged on the basis of the example shown on FIG. 4:

According to a first use case, the IED equipment is correctly authenticated on the access network but is not authenticated normally on the Smartgrid application. This scenario may be encountered in the case of multiple authentication attempts on the Smartgrid application, in the case where the timer expires and/or in the case of an authentication failure on the Smartgrid application. The identifier (for example the IMSI) connected to the security element (for example the public identity of the certificate) used for the access request to the application is then stored in a database of suspicious equipments (for example the consistency database) for subsequent refusal of access to the application.

According to a second use case, the IED equipment authenticates correctly on the Smartgrid application but was not the subject of an earlier, successful authentication on the access network, made numerous failed prior attempts on the access network, and/or exceeded the allotted time. The identifier (for example the IMSI) connected to the security element (for example the public identity of the certificate) used for the access request to the application is again stored in a database of suspicious equipments (for example the consistency database) for subsequent access refusal to the application. The security element (for example the public identity of the certificate) used for the access request to the application is stored in a database of suspicious equipments for subsequent refusal of access to the application.

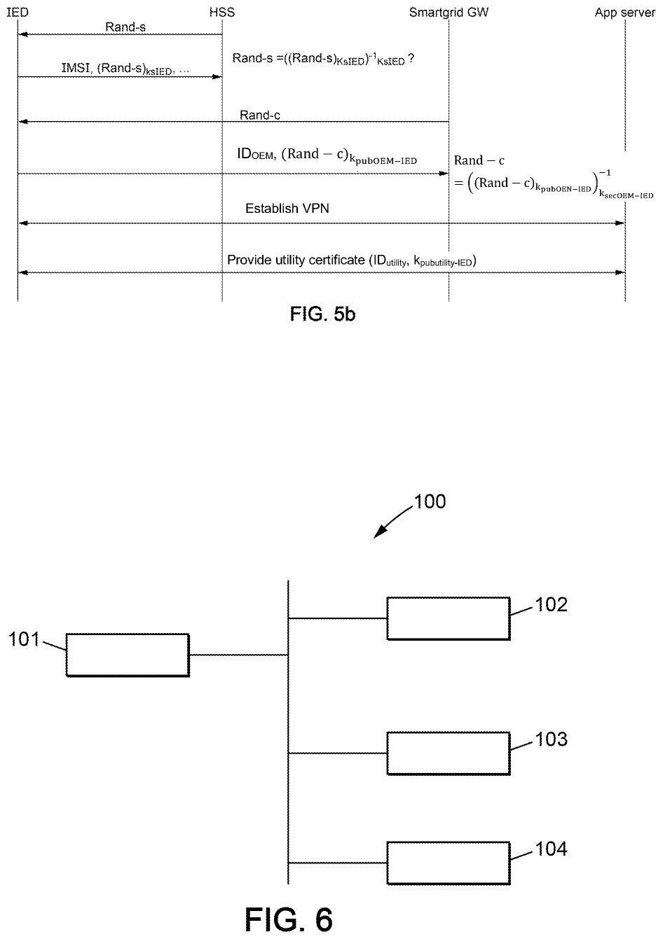

FIG. 5a shows an exemplary sequence of double authentication of an equipment according to one or more embodiments of the present subject disclosure.

The sequence example shown on FIG. 5a may be implemented in the non-limiting exemplary architecture shown on FIG. 2c, to which reference will be made for the description of FIG. 5a. In the example shown on FIG. 5a, the EPS access network comprises a 3GPP type radio access and uses a symmetric (with secret keys) type security mechanism, and the IED equipment is provided with an IMSI type identifier in this access network. As described above, the IED equipment may be provided with a SIM module with the corresponding IMSI identifier and a secret key. The PDN network may be an IP network which uses an asymmetric type security mechanism with an authentication process using a certificate with which the IED equipment is also provided.

Shown on FIG. 5a is an example of double authentication of an IED equipment with an EPS network comprising a radio access network and a core network comprising an HSS function, and with a PDN network, for data communication between the IED equipment and an application server on the PDN network. The proposed method illustrated in FIG. 5a uses the “Smartgrid GW/consistency” server which combines a server providing an authentication management function with a consistency management server (“consistency server”) provided with a consistency database, for example according to one or more embodiments described above.

The following notations are used in FIGS. 5a and 5b:

IDutility: the digital identity of the equipment provided by the “utility” company from the standpoint of the second network (for example by the PKI of the PDN network).

Rand-s: the random questions generated by the HSS for each access connection.

Rand-u: the random challenge generated by the “Smartgrid GW/consistency” server (the letter “u” standing for “utility”) for each application authentication.

Rand-c: the random question generated (once) for ensuring a secured connection to the database of identifiers assigned by the equipment manufacturer for the enrollment of the “utility” certificate.

k_{s-IED}: the security key contained in the SIM module of the IED equipment.

The action of encrypting a magnitude X with a secret key ks is denoted (X)ₖₛ

The action of decrypting a magnitude X with a secret key ks is denoted (X)⁻¹ₖₛ

k_{pubutility-IED}: the public key contained in the certificate for the equipment once enrolled, which links this key with the identity of the equipment assigned by the “utility.”

k_{secutility-IED}: the private key known only to the PKI-E (“Smartgrid GW/consistency” server) of the equipment once enrolled.

k_{pubOEM-IED}: the public key contained in the OEM certificate for the equipment before enrollment, which links this key with the identity of the equipment assigned by the equipment manufacturer

k_{secOEM-IED}: the private key known only to the PKI-E (“Smartgrid GW/consistency” server) of the equipment before enrollment by the “utility”

IMSI: the identifier of the IED equipment within the meaning of the 3GPP

ID_{OEM}: the digital ID of the equipment provided by the manufacturer of the equipment from the standpoint of the second network (for example by the PKI of the PDN network)

Referring to FIG. 5a, a request for connection to the 3GPP network issued by the IED equipment gives rise to a random challenge (Rand-s) generated by the HSS and transmitted to the IED equipment. The IED equipment responds ((Rand-s)_{ks-IED}) with its IMSI identifier (IMSI) and the random question encrypted with its secret key (k_{s-IED}).

Upon receiving a response from the IED equipment, the HSS verifies that the question was correctly encrypted by decrypting it with the secret key of the IED equipment: (Rand-s=((Rand-s)_{k-sIED})⁻¹_{ks-IED}).

Once this verification is successfully completed, the HSS sends to the “Smartgrid GW/consistency” server the IMSI identifier received from the IED equipment. In the scenarios where the IMSI identifier is not sent to the HSS with the authentication request or the response from the IED equipment (or more generally the identifier of the equipment used by the “Smartgrid GW/consistency” server for the proposed double authentication is not sent to the HSS or is not sent to the server by the HSS), the “Smartgrid GW/consistency” server may, in one or more embodiments, be configured for requesting that the IED equipment provide it with its identifier, possibly via the HSS as shown on the figure.

The “Smartgrid GW/consistency” server may then use the IMSI identifier of the IED equipment thus obtained for performing a security verification based on this identifier, according to one or more embodiments of the proposed method, in particular by querying a consistency database as described in the present subject disclosure.

In the scenarios where the authentication sequence for the IED equipment is not stopped, the “Smartgrid GW/consistency” server generates a random question (Rand-u) as part of performing the authentication of the IED equipment for access to the PDN network application server. This question leads to a response ((Rand-u)_{kpubutility-IED}) from the IED equipment with an identifier (ID) and the random question encrypted with its public key (k_{pubutility-IED}).

Upon receiving a response from the IED equipment, the “Smartgrid GW/consistency” server verifies that the question was correctly encrypted by decrypting it with the secret key for the IED equipment (k_{secutility-IED}): (Rand-u=((Rand-u)_{kpubutility-IED})⁻¹k_{secutility-IED}).

Independently of this verification, or, depending on the embodiments, once this verification is complete, the “Smartgrid GW/consistency” server may then use the IMSI identifier obtained for the IED equipment and the public key (k_{pubutility-IED}) of the IED equipment to perform a security verification on the basis of this identifier—public key pair, according to one or more embodiments of the proposed method, in particular by querying a consistency database and/or by using a timer as described in the present subject disclosure.

In scenarios where the authentication sequence for the IED equipment ends successfully, a secured tunnel, for example of the VPN type, may be implemented between the IED equipment and the application server for exchanging data.

FIG. 5b shows providing a “utility” (or “operator”) certificate by replacing the initial certificate with which the IED equipment was provided that was provided by the manufacturer of the equipment (e.g. an OEM) and that contains for example an equipment manufacturer identifier (ID_{OEM}) according to one or more embodiments.

The authentication method shown on FIG. 5b is similar to the one shown on FIG. 5a, except that the authentication in the second network (for example a PDN network) uses an equipment manufacturer public key (or certificate) (k_{pubOEM-IED}) with which the IED equipment was initially provided by the equipment manufacturer.

In scenario where the authentication sequence for the IED equipment ends successfully, a secured tunnel, for example of the VPN type, can be implemented between the IED equipment and the application server for exchanging data.

This secured tunnel can then be used to provide the IED equipment with another public key (another certificate, containing for example a utility identifier IDutility) (k_{pubutility-IED}), generated for example by the operator (or “utility”), so that the IED equipment may use this new public key for all subsequent access requests to the application server.

FIG. 6 shows an exemplary architecture of an equipment for the implementation of the proposed method according to one or more embodiments.

Referring to FIG. 6, the device 100 comprises a controller 101, operatively coupled to a communication interface 102 and a memory 103, which drives an authentication management module 104.

The communication interface 102 comprises one or more communication units, each being configured for sending and/or receiving data according to one or more data communication protocols (by wire or wireless), for example WLAN, ethernet, UMTS, LTE and LTE-A.

The controller 101 is configured for driving the authentication management module 104 and the communication interface 102 for implementing one or more embodiments of the proposed method.

The authentication management module 104 is configured for implementing the proposed method by a server connected to a data communication network to which an application server is connected, for the management of the authentication of equipments requesting access to the application server for the exchange of data in connection with execution of an application, such as, for example, a service application. In particular, the authentication management module 104 may be configured for providing the functions and performing the actions described in the present subject disclosure for implementation of the proposed method by an authentication management unit and/or a consistency management server connected to a consistency database.

The device 100 may be a computer, a network of computers, an electronic component, or another device comprising a processor operatively coupled to memory, and also, according to the chosen implementation, a data storage unit and other associated hardware elements such as a network interface and media reader for reading a removable storage medium and writing on such a medium (not shown on the figure). The removable storage medium may be, for example, a compact disk (CD), a digital video/polyvalent disk (DVD), a flash drive, a USB key, SSD memory, etc. Depending on the embodiment, the memory, the data storage unit or the removable storage medium contain instructions which, when they are executed by the controller 101, lead this controller 101 to carry out or control the authentication management module 104 and communication interface 102 parts from the implementation examples of the proposed method described in the present subject disclosure. The controller 101 may be a component implementing a processor or a calculation unit for management of communication according to the proposed method and the control units 102 and 104 of the device 100.

The device 100 may be implemented in software form, hardware form, as an application-specific integrated circuit (ASIC), or as a combination of hardware and software elements, such as for example a software program intended to be loaded and run on an FPGA type component (Field Programmable Gate Array). Similarly the authentication management module 104 may be implemented in software form, hardware form, as an ASIC or as a combination of hardware and software elements, such as for example a software program intended to be loaded and run on an FPGA type component.

Depending on the chosen embodiment, some acts, actions, events or functions of each of the methods described in the present subject disclosure may be performed or produced in a different order from the one in which they are described, or can be added, merged or even not performed or not produced on a case by case basis. Further, in some embodiments, some acts, actions or events may be performed or produced concurrently and not successively.

Even though described through some number of detailed implementation examples, the proposed method and the device for implementation of an embodiment of the method comprise various variants, modifications and improvements which will appear obvious to the person skilled in the art, wherein it is understood that these various variants, modifications and improvements are part of the scope of the invention, as defined by the following claims. Further, various aspects and characteristics described above can be implemented together or separately, or else substituted for each other, and the whole of the various combinations and sub-combinations of the aspects and characteristics are within the scope of the invention. Further, it is possible that some systems and equipment described above do not fully incorporate the entirety of the modules and functions described for the preferred embodiments.

1. A method for managing authentication of an equipment in a data communication system for the exchange of data between the equipment and an application server of the system, wherein the system comprises a first data communication network configured for using a first security function for securing data communication within the first network, operatively coupled to a second data communication network configured for using a second security function for securing data communication within the second network, wherein the method comprises, in an authentication management unit of the system implemented in a node of the second communication network:
receiving an authentication request from the equipment according to the second security function for access to the application server;
determining whether an equipment identifier in the first communication network was received further to receiving an authentication request from the equipment according to the first function; and
in case the equipment identifier was not received, generating an authentication failure response for the equipment.

2. The method according to claim 1, further comprising receiving an authentication request from the equipment according to the first security function on the first communication network, wherein the authentication request uses the equipment identifier.

3. The method according to claim 2, wherein the system further comprises a database preconfigured with a correspondence between the identifier and the security element for the second security function for authentication requests from the equipment according to the second function addressed to the second network, the method further comprising sending to the database a request for verification of recording the received identifier in the database, wherein the request comprises the received identifier.

4. The method according to claim 3, further comprising: upon receiving a response of absence of a record for the received identifier in the database, or a response indicating an anomaly relative to one or more previous authentication requests for the equipment according to the first security function in the first communication network and/or according to the second security function in the second communication network, generating the authentication failure response for the equipment.

5. The method according to claim 2, wherein the system further comprises a database preconfigured with the correspondence between the identifier and the security element for the second security function for authentication requests from the equipment according to the second function addressed to the second network, the method further comprising:
receiving an authentication request from the equipment according to the second security function on the second communication network, wherein the authentication request uses the security element;
sending to the database a request for verification of recording the received identifier corresponding to the received security element in the database, wherein the request comprises the received identifier and the received security element.

6. The method according to claim 5 further comprising: upon receiving a response from the database indicating that there is no correspondence between the identifier and the received element, generating the authentication failure response for the equipment.

7. The method according to claim 2 further comprising:
initializing a timer to a preset duration upon receiving the authentication request from the equipment according to the first security function on the first communication network; and
when no authentication request for the equipment according to the second security function on the second communication network is received before expiration of the timer, generating the authentication failure response for the equipment.

8. The method according to claim 1, wherein the system further comprises a database preconfigured with the correspondence between the identifier and the security element for the second security function for authentication requests from the equipment according to the second function addressed to the second network, the method further comprising:
sending to the database a request for recording the authentication failure of the equipment corresponding to the identifier and/or the security element.

9. The method according to claim 1, wherein the equipment is provided with an initial security element for the second security function for authentication requests from the equipment according to the second function addressed to the second network, the method comprising:
receiving an authentication request from the equipment according to the second security function on the second communication network, wherein the authentication request uses the initial security element;
generating an authentication success response for the equipment in order to authorize access of the equipment to the application server;
upon receiving a message from the application server indicating that the equipment is recorded in the application server by using a secured connection between the equipment and the application server following authentication success of the equipment, obtaining an operator security element; and
sending the operator security element to the application server for sending to the equipment by using the secured connection.

10. The method according to claim 9, wherein the system further comprises a database preconfigured with the correspondence between the identifier and an initial security element for the second security function for authentication requests from the equipment according to the second function addressed to the second network, the method further comprising:
sending to the database a request to update the initial security element with the operator security element.

11. The method according to claim 1, wherein the system further comprises a database preconfigured with the correspondence between the identifier and the security element for the second security function for authentication requests from the equipment according to the second function addressed to the second network, the method further comprising:
sending to the database a request for recording the authentication failure of the equipment corresponding to the identifier and/or the security element.

12. An apparatus, wherein the apparatus is configured for managing authentication of an equipment in a data communication system for the exchange of data between the equipment and an application server of the system, wherein the system comprises a first data communication network configured for using a first security function for securing data communication within the first network, operatively coupled to a second data communication network configured for using a second security function for securing data communication within the second network, and the apparatus comprises a processor, a data communication interface and memory operatively coupled to the processor, and the apparatus is implemented in a node of the second communication network, wherein the processor is configured to:
receive an authentication request from the equipment according to the second security function for access to the application server;
determine whether an equipment identifier in the first communication network was received further to receiving an authentication request from the equipment according to the first function; and
in case the equipment identifier was not received, generate an authentication failure response for the equipment.

13. A non-transitory computer-readable storage medium for a computer executable program, comprising a set of data representing one or more programs, wherein said one or more programs comprise instructions for, during execution of said one or more programs by a computer comprising a processing unit operatively coupled with a memory and with an input/output interface module, driving the computer to implement a method for managing authentication of an equipment in a data communication system for the exchange of data between the equipment and an application server of the system, wherein the system comprises a first data communication network configured for using a first security function for securing data communication within the first network, operatively coupled to a second data communication network configured for using a second security function for securing data communication within the second network, wherein the method comprises, in an authentication management unit of the system implemented in a node of the second communication network:
receiving an authentication request from the equipment according to the second security function for access to the application server;
determining whether an equipment identifier in the first communication network was received further to receiving an authentication request from the equipment according to the first function; and
in case the equipment identifier was not received, generating an authentication failure response for the equipment.

14. The apparatus according to claim 12, wherein the processor is further configured to receive an authentication request from the equipment according to the first security function on the first communication network, wherein the authentication request uses the equipment identifier.

15. The apparatus according to claim 12, wherein the system further comprises a database preconfigured with the correspondence between the identifier and the security element for the second security function for authentication requests from the equipment according to the second function addressed to the second network, and wherein the processor is further configured to send to the database a request for verification of recording the received identifier in the database, wherein the request comprises the received identifier.

16. The apparatus according to claim 12, wherein the processor is further configured to: upon receiving a response of absence of a record for the received identifier in the database, or a response indicating an anomaly relative to one or more previous authentication requests for the equipment according to the first security function in the first communication network and/or according to the second security function in the second communication network, generate the authentication failure response for the equipment.

17. The apparatus according to claim 12, wherein the system further comprises a database preconfigured with the correspondence between the identifier and the security element for the second security function for authentication requests from the equipment according to the second function addressed to the second network, wherein the processor is further configured to:
receive an authentication request from the equipment according to the second security function on the second communication network, wherein the authentication request uses the security element;
send to the database a request for verification of recording the received identifier corresponding to the received security element in the database, wherein the request comprises the received identifier and the received security element.

18. The apparatus according to claim 12: wherein the processor is further configured to: upon receiving a response from the database indicating that there is no correspondence between the identifier and the received element, generate the authentication failure response for the equipment.

19. The apparatus according to claim 12, wherein the processor is further configured to: initialize a timer to a preset duration upon receiving the authentication request from the equipment according to the first security function on the first communication network; and when no authentication request for the equipment according to the second security function on the second communication network is received before expiration of the timer, generate the authentication failure response for the equipment.

20. The apparatus according to claim 12, wherein the system further comprises a database preconfigured with the correspondence between the identifier and the security element for the second security function for authentication requests from the equipment according to the second function addressed to the second network, wherein the processor is further configured to send to the database a request for recording the authentication failure of the equipment corresponding to the identifier and/or the security element.
